(19) United States
(12) Patent Application Publication
(10) Pub. No.: US 2014/0162865 A1
(43) Pub. Date: Jun. 12, 2014

(54) ENGINE OIL COMPOSITION

(71) Applicant: CATERPILLAR INC., Peoria, IL (US)

(72) Inventors: Paul W. Park, Peoria, IL (US); Hind M. Abi-Akar, Peoria, IL (US)

(73) Assignee: Caterpillar Inc., Peoria, IL (US)

(21) Appl. No.: 13/710,877

(22) Filed: Dec. 11, 2012

(51) Int. Cl. B01J 38/00; B01J 38/02

(52) U.S. Cl. CPC B01J 38/00; B01J 38/02
USPC 502/56; 508/423; 502/20

(57) ABSTRACT

An engine oil including a base oil in a range of about 70 to 85 wt %. The engine oil includes at least one additive in a range of about 15 to 30 wt %, such as, an antioxidant, a cleaning agent/detergent, a dispersing agent, a wear resistant agent, a viscosity index improving agent, a pour point depressant, a rust/corrosion inhibiting agent, a foam inhibiting agent, and an extreme pressure agent. The engine oil further includes an additive including an organometallic compound of a catalyst consisting of a catalytic element in a range of about 0.001 to 0.05 wt %.

### TECHNICAL FIELD

The present disclosure relates generally to an engine oil composition and, more particularly to the engine oil composition to improve aftertreatment system performance.

### BACKGROUND

Various types of additives are selectively used to with engine oil and/or fuel to improve exhaust gas aftertreatment performance in an engine system. For example, U.S Publication number 20070277431 discloses engine oil composition comprising a compound containing a metallic element, wherein a metal oxide obtained by oxidizing the metallic element has a catalytic action which promotes burning of a particulate matter contained in exhaust gases discharged from an internal combustion engine.

### SUMMARY

In one aspect, the present disclosure discloses an engine oil including a base oil in a range of about 70 to 85 wt % and one or more additive in a range of about 15 to 30 wt %. The additives includes, such as, an antioxidant, a cleaning agent/detergent, a dispersing agent, a wear resistant agent, a viscosity index improving agent, a pour point depressant, a rust/corrosion inhibiting agent, a foam inhibiting agent, and an extreme pressure agent. The additives further include an organometallic compound of a catalyst consisting of a catalytic element in a range of about 0.001 to 0.05 wt %.

Other features and aspects of this disclosure will be apparent from the following description and the accompanying drawings.

### BRIEF DESCRIPTION OF THE DRAWINGS

FIG. 1 is an engine system, according to an aspect of the present disclosure; and

FIG. 2 is an exemplary method flow chart for regenerating an aftertreatment system in the engine system, according to an embodiment of the present disclosure.

### DETAILED DESCRIPTION

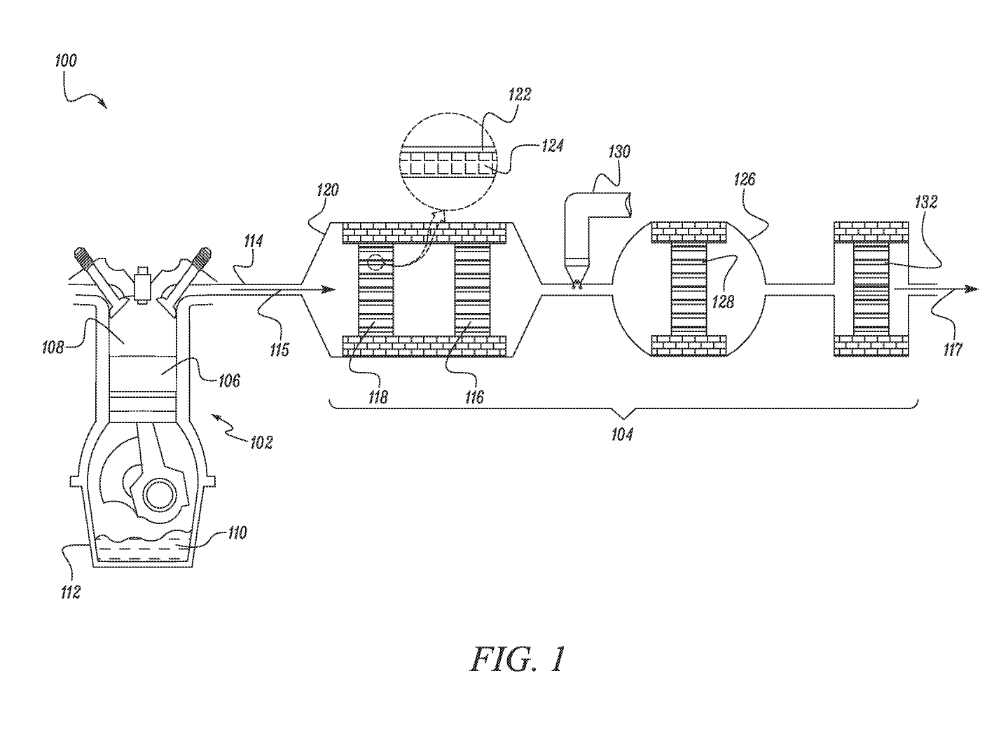

FIG. 1 illustrates an engine system 100, the engine system 100 may include an engine 102 and an aftertreatment system 104 operatively connected to the engine 102. The engine 102 may be any type of engine (internal combustion, gas, diesel, gaseous fuel, natural gas, or propane based engine etc.), may be of any size, with any number of cylinders, and in any configuration (“V,” in-line, radial, etc.). The engine 102 may be used to power any machine or other device, including on-highway trucks or vehicles, off-highway trucks or machines, earth moving equipment, generators, aerospace applications, locomotive applications, marine applications, pumps, stationary equipment, or other engine powered applications.

In the exemplary embodiment shown in FIG. 1, the engine 102 may include a piston 106 configured to reciprocate within a combustion chamber 108 between a top dead point and a bottom dead point. During operation, engine oil 110 present in the oil sump 112 provides lubrication between the moving piston 106 and the combustion chamber 108 to prevent overheating. The engine oil 110 may also clean, prevent corrosion, and provide cooling by carrying heat away from moving parts of the engine system 100.

The engine oil 110 may be primarily derived from petroleum-based or non-petroleum-synthesized chemical compounds, and includes a mineral oil, a synthetic oil, or a partial synthetic oil serving as a base oil in a range of about 70 to 85 wt %. The engine oil 110 may further include one or more additives in a predetermined combination such as, but are not limited, an antioxidant, a cleaning agent/detergent, a dispersing agent, a wear resistant agent, a viscosity index improving agent, a pour point depressant (superplasticizer), a rust/corrosion inhibiting agent, a foam inhibiting agent, and an extreme pressure agent, in a range of about 15 to 30 wt %.

The engine system 100 may further include an exhaust manifold 114 to route an engine exhaust 115 from the engine 102 to the aftertreatment system 104. The engine exhaust 115 may include gaseous and solid materials, such as particulate matter (mainly unburned carbon particles referred to as soot), carbon monoxide, unburned hydrocarbons, and oxides of Nitrogen (NOₓ). The aftertreatment system 104 is configured to receive the engine exhaust 115 and refines it to produce clean engine exhaust 117 that is routed to the atmosphere. The aftertreatment system 104 may include a diesel oxidation catalyst (DOC) 116, and a diesel particulate filter (DPF) 118, which may be a catalyzed DOC 116 and a catalyzed DPF 118. The DOC 116 and the DPF 118 may be housed in a canister 120. Alternatively, the DOC 116 and the DPF 118 may be placed in individual canisters.

The DOC 116 and the DPF 118 may include a catalyst as a catalyst washcoat 122 provided on a substrate 124. The substrate 124 may have a honeycomb structure or an elongated channel shaped structure or a metal mesh structure or a sintered metal foam structure, or any other type of structure having high surface area configuration. The substrate 124 may be made from a suitable ceramic or composites or metallic compounds, for example silicon carbide, cordierite, stainless steel or the like. The catalyst washcoat 122 may consist of one or more catalytic elements such as platinum (Pt), cerium (Ce), cobalt (Co), palladium (Pd). However, other catalytic elements selected from the group consisting of 4th period elements, lanthanides, and 4th group transition metal elements, for example, iron (Fe), vanadium (V), chromium (Cr), manganese (Mn), nickel (Ni), copper (Cu), and tin (Sn) may be also used as the catalyst washcoat 122. During operation, the catalyst washcoat 122 present in the DOC 116 and/or the DPF 118 provides a catalytic action to promote burning of CO, hydrocarbons, and particulate matter by lowering an activation energy as well as the reaction temperature of the CO, hydrocarbons, and particulate matter present in the engine exhaust 115 to a range that lie within a range of the engine exhaust 115 temperature range.

In an embodiment, the aftertreatment system 104 may also include a selective catalytic reduction (SCR) device 126 having a catalyst substrate 128, including the catalyst washcoat, located downstream of a reductant injector 130. A gaseous or liquid reductant, most commonly urea or a water/urea mixture, may be sprayed or injected into the engine exhaust 115 upstream of the catalyst substrate 128 by the reductant injector 130. As the reductant is absorbed by the catalyst washcoat on the catalyst substrate 128, the reductant may react with NOₓ (NO and NO₂) present in the engine exhaust 115 to form water (H₂O) and elemental nitrogen (N₂). This reduction process performed by the SCR device 126 may be most effective when a concentration of NO to NO₂ supplied is close to a pre-determined ratio. The DOC 116 located upstream of the SCR device 126, may facilitate the conversion of NO to NO₂ to control the concentration of NO to NO₂ substantially close to the pre-determined ratio.

Further, during operation of the engine system 100, it may be possible that an excess amount of reductant (i.e., urea or water/urea mixture) may get injected into the engine exhaust 115. In this situation, known as “reductant slip”, some amount of the reductant may pass through the catalyst substrate 128 to the atmosphere. To minimize the reductant slip, another oxidation catalyst, an Ammonia Oxidation (AMOX) catalyst 132 may be located downstream of the SCR device 126. The AMOX catalyst 132 may also include a substrate coated with the catalyst washcoat, which oxidizes residual reductant present in the engine exhaust 115 to form H₂O and N₂. In various other embodiment of the present disclosure, the aftertreatment system 104 may include the SCR device 126 only or a combination of the SCR device 126 and the AMOX catalyst 132 without the DOC 116 and the DPF 118.

According to an embodiment of the present disclosure, the engine oil 110 may be used to deliver the catalytic element to the aftertreatment system 104. In an aspect of the present disclosure, the engine oil 110 may include one or more organometallic compounds of the catalyst including the catalytic element, such as, Pd, Co, Ce, and Pt. The organometallic compounds may include organic acid salts, amine salts, oxygenates, phenates and sulfonates of the catalyst, which are soluble in the engine oil 110. In an embodiment, the catalytic element may be present in the engine oil 110, in the form of the organometallic compounds, in a range of about 0.001 to 0.05 wt % (5 ppm to 500 ppm) by weight of the engine oil 110. During operation of the engine system 100, some of the engine oil 110 may leak into the combustion chamber 108 through a gap present between the piston 106 and the combustion chamber 108. As a result, some of the organometallic compounds present in the engine oil 110 may also undergo combustion in the combustion chamber 108 and oxidizes the organometallic compounds present in the engine oil 110. Subsequently, the oxidized organometallic compounds discharged with the engine exhaust 115 and deposited or captured within the DOC 116 and/or DPF 118 along with the particulate matter. The oxidized organometallic compounds present in the engine exhaust 115 may convert into an active catalytic element and get deposited on the catalyst washcoat 122 to aid in regeneration of the DOC 116 and/or the DPF 118 of the aftertreatment system 104. Moreover, in another embodiment, the organometallic compounds of the catalyst may include the catalytic element, such as, V, Fe, and Cu. Such that the oxidized organometallic compounds present in the engine exhaust 115 may also aid in the regeneration of the catalyst washcoat in the SCR device 126 and the AMOX catalyst 132 by depositing the catalytic element.

In an exemplary embodiment, the organometallic compounds of the catalyst may be represented by general formula: M(OR)ₚ(RCOCHCOR)_{q}. Wherein M is the catalytic element and is selected from a group including of, but not limited to, Pd, Pt, Co, Ce, Fe, V, Cr, Mn, Ni, Cu, and Sn. R represent a alkyl or alkoxy group including, but not limited to, a methyl group, an ethyl group, an n-propyl group, an iso-propyl group, an n-butyl group, a tert-butyl group, an n-pentyl group, and a 2-ethoxyethyl group, methoxy group, an ethoxy group, an n-propoxy group, an iso-propoxy group, an n-butoxy group, a tert-butoxy group, a 2-ethylhexyloxy group, and a lauryloxy group. Further, p and q may represent a natural number.

In accordance with another embodiment of the present disclosure, the engine oil 110 additives such as, the oxidation inhibiting agent, the wear resistant agent, the cleaning agents, and the dispersing agent which contain a metal cations, for example Zinc (Zn), may be substituted by the catalytic element present in the catalyst washcoat 122 to form a group of stable organometallic compounds for regeneration of the DOC 116, the DPF 118, the SCR device 126 and the AMOX catalyst 132. For example, Zinc dithiophosphate (often referred to as ZDDP) having a general formula Zn[(S2P(OR)2]2 is generally used as the oxidation inhibiting agent, and the wear resistant agent in the engine oil 110. Wherein R represents alkyl groups which can be straight carbon chains of various lengths, preferably less than 20 carbons. R alkyl groups can also be various isomers of branched or straight chains of 2-20 carbon length. The branched alkyl groups can be, but not limited to, straight chains or any branched version of propyl, butyl, pentyl, hexyl, heptyl, octyl, nonyl functional groups. In an aspect of the present disclosure, Zn cation in the ZDDP may be substituted by the catalytic elements to form a range of organometallic compounds having general formula, for example, but not limited to, Pd[(S₂P(OR)₂]₂, Co[(S₂P(OR)₂]₂, Pt[(S₂P(OR)₂]₂, Ce[(S₂P(OR)₂]₂, V[(S₂P(OR)₂]₂, Fe[(S₂P(OR)₂]₂, and Cu[(S₂P(OR)₂]₂ which may be used as the additives in the engine oil 110 for DOC 116 and/or DPF 118 or SCR 126 and/or AMOX 132 regeneration.

Moreover, the aliphatic and aromatic amine, phenol, hindered phenol, or sulfurized phenol derivatives are generally used as the oxidation inhibiting agent in the engine oil 110. In yet another aspect of the present disclosure, Pd, Pt, Ce, Co, V, Fe, or Cu derivatives of the amines and phenols oxidation inhibiting agents may be used as additive in the engine oil 110.

In yet another embodiment of the present disclosure, the metal component of the rust/corrosion inhibiting agent, the cleaning agent, the dispersing agent such as basic metal alkyl or aryl sulfonates, metal phenolates, metal phosphonates, metal sulfonates, metallic sulfosuccinate, phenate, salicylate, and metal derivatives of alkyl succinimides and alkyl succinic esters may be substituted by the catalytic element, such as, Pd, Pt, Ce, Co, V, Fe, or Cu.

### INDUSTRIAL APPLICABILITY

The industrial applicability of the engine oil 110 having an additive including the organometallic compounds of the catalytic elements described herein will be readily appreciated from the foregoing discussion. Typically, the fuel based additives containing the compounds of the catalytic elements present in the catalyst washcoat 122 are used to aid in the regeneration of the catalyst present in the aftertreatment system 104. However, it was observed that during operation of the engine system 100, the consumption rate of fuel may significantly vary. Thus, estimation for an optimal range for weight percentages of the fuel based additives and also the catalytic elements for continuous regeneration of the DOC 116 and/or DPF 118 or SCR 126 and/or AMOX 132 is difficult to be done. Moreover, an operator has to carry additives in an onboard container to deliver the additives in the fuel as per an anticipated consumption rate of the fuel and of that of the catalytic elements therefore.

During operation of the engine system 100, the consumption rate of the engine oil 110 remains substantially constant and this may provide a good estimate for the depletion of the additives present in the engine oil 110. Thus, based on a design requirement of the engine system 100 and more specifically based on the design of the aftertreatment system 104, an optimal percentage for weight percentages of the organometallic compounds of the catalytic elements present in the catalyst washcoat 122 in the engine oil 110 required for a continuous regeneration of the DOC 116 and/or DPF 118 or SCR 126 and/or AMOX 132 can be easily estimated. Moreover, the base oil that constitutes the primary component of the engine oil 110 provides a good soluble medium for the organometallic compounds of the catalytic elements as compared to the fuel.

Using this method the additives such as the organometallic compounds of the catalytic elements may be much easily and accurately delivered to the downstream DOC 116, the DPF 118, the SCR device 126 and/or the AMOX catalyst 132 and get deposited to help in the catalyst regeneration. Further, depending on engine type and application, different engine oils can customize the weight percentages of the organometallic compounds of the catalytic elements.

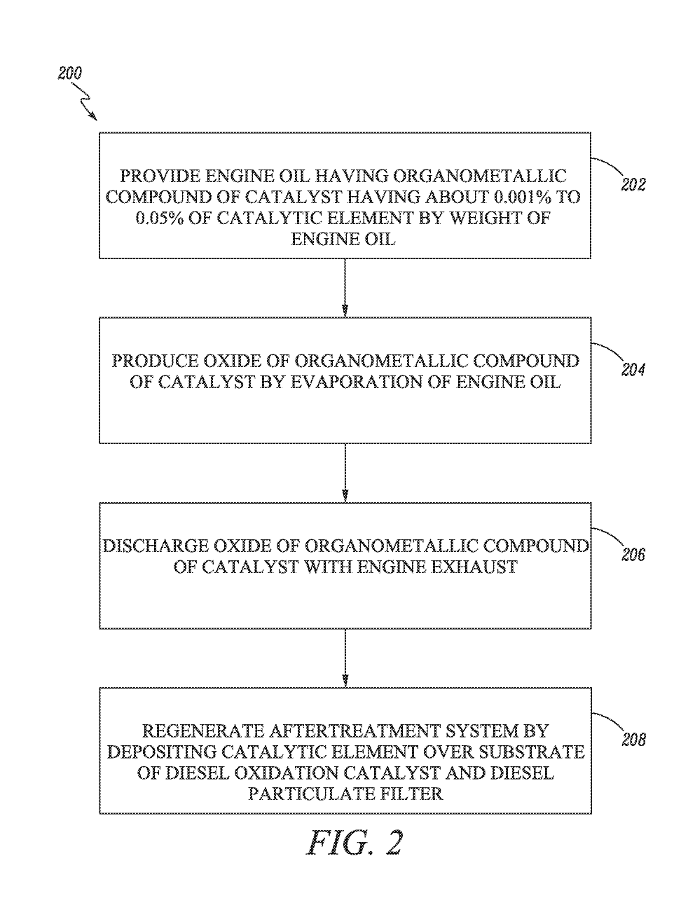

FIG. 2 illustrated an exemplary method 200 for regenerating the aftertreatment system 104 in the engine system 100, according to an embodiment of the present disclosure. At step 202, the engine system 100 may be provided with the engine oil 110 having the organometallic compound of the catalyst including the catalytic element in the range from about 0.001 to 0.05 wt %. During operation of the engine system 100, at step 204, the catalytic element are produced by the oxidation of the organometallic compound of the catalytic element. As described above, the organometallic compound of the catalytic element present in the engine oil 110 may undergo combustion in the combustion chamber 108 to produce the catalytic element which is present in the catalyst washcoat 122. Moreover, the engine oil 110 may come in contact with the high temperature engine exhaust 115 at any other location in the engine system 100, such as, exhaust manifold 114, to produce the catalytic element present in the catalyst washcoat 122.

At step 206, the catalytic element may be discharged with the engine exhaust 115 and enter into the aftertreatment system 104. The particulate matter also present in the engine exhaust 115 may get trapped and burned in the DPF 118 of the aftertreatment system 104. However, due to the continuous working of the engine system 100 the catalytic elements in the catalyst washcoat 122 present on the substrate 124 may become partially covered or depleted by the continuous burning of the particulate matter. Thus, impedes the performance of the DOC 116 or DPF 118 and also lowers an overall performance of the aftertreatment system 104. According to an aspect of the present disclosure, at step 208, the catalytic element present in the engine exhaust 115 (produced by the evaporation of the engine oil 110 in the combustion chamber 108, see step 204) may aid in regeneration of the aftertreatment system 104 by depositing the catalytic element on the catalyst washcoat 122 in the DOC 116, the DPF 118, the SCR device 126 and/or the AMOX catalyst 132 and thus replenish the catalyst and aid in the continuous regeneration of the aftertreatment system 104.

Although the embodiments of the present disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. An engine oil comprising:
a base oil in a range of about 70 to 85 wt %;
at least one additive in a range of about 15 to 30 wt %, the additives selected from a group consisting of
an antioxidant,
a cleaning agent/detergent,
a dispersing agent,
a wear resistant agent,
a viscosity index improving agent,
a pour point depressant,
a rust/corrosion inhibiting agent,
a foam inhibiting agent,
an extreme pressure agent, and
an organometallic compound of a catalyst consisting of a catalytic element in a range of about 0.001 to 0.05 wt %.

2. The engine oil of claim 1, wherein the catalytic element is selected from a group consisting of Pd, Co, Ce, Pt, V, Fe, and Cu.

3. The engine oil of claim 1, wherein the catalytic element is selected from a group consisting of 4th period elements, lanthanides, and 4th group transition metal elements.

4. The engine oil of claim 1, wherein the organometallic compound of the catalyst is selected from a group consisting of organic acid salts, amine salts, oxygenates, phenates and sulfonates of Pd, Co, Ce, Pt, V, Fe, and Cu.

5. The engine oil of claim 1, wherein the organometallic compound of the catalyst is selected from a group consisting of dithiophosphate of Pd, Co, Ce, Pt, V, Fe, and Cu.

6. The engine oil of claim 1, wherein the organometallic compound of the catalyst is selected from a group consisting of aliphatic or aromatic amine and phenol derivatives of Pd, Co, Ce, Pt, V, Fe, and Cu.

7. An additive for an engine oil to improve performance of an aftertreatment system, the additive comprising an organometallic compound of a catalyst consisting of a catalytic element in a range of about 0.001 to 0.05 wt %.

8. The additive of claim 7, wherein the catalytic element is selected from a group consisting of Pd, Co, Ce, Pt, V, Fe, and Cu.

9. The additive of claim 7, wherein the catalytic element is selected from a group consisting of 4th period elements, lanthanides, and 4th group transition metal elements.

10. The additive of claim 7, wherein the organometallic compound of the catalyst is selected from a group consisting of organic acid salts, amine salts, oxygenates, phenates and sulfonates of Pd, Co, Ce, Pt, V, Fe, and Cu.

11. The additive of claim 7, wherein the organometallic compound of the catalyst is selected from a group consisting of dithiophosphate of Pd, Co, Ce, Pt, V, Fe, and Cu.

12. The additive of claim 7, wherein the organometallic compound of the catalyst is selected from a group consisting of aliphatic or aromatic amine and phenol derivatives of Pd, Co, Ce, Pt, V, Fe, and Cu.

13. A method for regenerating an aftertreatment system in an engine system, the method comprising:
providing an engine oil having an organometallic compound of a catalyst consisting of a catalytic element in a range of about 0.001 to 0.05 wt %;
producing an oxide of the organometallic compound by evaporation of the engine oil;
discharging the oxide of the organometallic compound with engine exhaust;
converting to the catalytic element from the oxide of the organometallic compound; and
regenerating the aftertreatment system by depositing the catalytic element over a catalyst washcoat of a present in the aftertreatment system.

14. The method of claim 13, wherein the providing the engine oil having the organometallic compound of the catalyst includes adding organic acid salts, amine salts, oxygenates, phenates and sulfonates of the catalytic element is selected from a group consisting of Pd, Co, Ce, Pt, V, Fe, and Cu.

15. The method of claim 13, wherein the providing the engine oil having the organometallic compound of the catalyst includes adding dithiophosphate of the catalytic element is selected from a group consisting of Pd, Co, Ce, Pt, V, Fe, and Cu.

16. The method of claim 13, wherein the providing the engine oil having the organometallic compound of the catalyst includes adding aliphatic or aromatic amine and phenol derivatives of the catalytic element is selected from a group consisting of Pd, Co, Ce, Pt, V, Fe, and Cu.

17. The method of claim 13, wherein producing the oxide of the organometallic compound by evaporation includes combusting the organometallic compound of the catalyst in a combustion chamber of the engine system.

18. The method of claim 13, wherein the catalytic element brings down a combustion temperature of CO, hydrocarbons and particulate matter present in the engine exhaust.
